(19) United States
(12) Patent Application Publication
(10) Pub. No.: US 2025/0103211 A1
(43) Pub. Date: Mar. 27, 2025

(54) ELECTRONIC DEVICE AND HOST DEVICE COUPLED TO MEMORY DEVICE

(71) Applicant: Silicon Motion, Inc., Hsinchu County (TW)

(72) Inventor: Wei-Ya Lee, New Taipei City (TW)

(73) Assignee: Silicon Motion, Inc., Hsinchu County (TW)

(21) Appl. No.: 18/731,370

(22) Filed: Jun. 3, 2024

(30) Foreign Application Priority Data
Sep. 21, 2023 (TW) 112135977

(51) Int. Cl. G06F 3/06

(52) U.S. Cl. CPC G06F 3/0613; G06F 3/0659; G06F 3/0679

(57) ABSTRACT

The present invention provides a host device coupled to a memory device, wherein the host device includes a processor, and the processor is configured to perform the steps of: (a) configuring a plurality of transport request descriptors in a memory; (b) writing a plurality of command descriptors into the memory in sequence, wherein a number of the command descriptors is greater than a number of the transport request descriptors; (c) selecting a transport request descriptor from the transport request descriptors sequentially and repeatedly, and determining a command descriptor sequentially without repetition; (d) modifying the transport request descriptor according to the command descriptor; (e) reading the transport request descriptor to send a command in the command descriptor to the memory device; and (f) determining whether a last command descriptor has been processed, if not, going back to step (c), and executing steps (c)-(f) in sequence.

### BACKGROUND OF THE INVENTION

### 1. Field of the Invention

The present invention relates to a host device coupled to a flash memory controller.

### 2. Description of the Prior Art

In a conventional flash memory controller that complies with Universal Flash Storage (UFS) standard, in order to test the performance of the flash memory controller when processing multiple commands, the host device will send multiple commands to the flash memory controller to observe the characteristics of the flash memory controller when processing these commands. However, since the current software architecture of the host device cannot quickly transmit a large number of commands to the flash memory controller, it cannot effectively test the limits of the flash memory controller in processing multiple commands.

### SUMMARY OF THE INVENTION

Therefore, the present invention proposes a command processing method that allows the host device to quickly send a large number of commands to the flash memory controller for processing, so as to solve the problems described in the prior art.

According to one embodiment of the present invention, a host device coupled to a memory device is disclosed. The memory device comprises a flash memory controller and a flash memory module, and the host device comprises a processor, and the processor is configured to perform the steps of: (a) configuring a plurality of transport request descriptors in a memory; (b) writing a plurality of command descriptors into the memory in sequence, wherein a number of the plurality of command descriptors is greater than a number of the plurality of transport request descriptors; (c) selecting a transport request descriptor from the plurality of transport request descriptors sequentially and repeatedly, and determine a command descriptor sequentially without repetition; (d) modifying the transport request descriptor according to the command descriptor; (e) reading the transport request descriptor to send a command in the command descriptor to the memory device; and (f) determining whether a last command descriptor of the plurality of command descriptors has been processed, if not, going back to step (c), and executing steps (c)-(f) in sequence.

According to one embodiment of the present invention, an electronic device, comprising a memory device and a host device is disclosed. The memory device comprises a flash memory controller and a flash memory module. The host device is coupled to the memory device, wherein the host device comprises a processor, and the processor is configured to perform the steps of: (a) configuring a plurality of transport request descriptors in a memory; (b) writing a plurality of command descriptors into the memory in sequence, wherein a number of the plurality of command descriptors is greater than a number of the plurality of transport request descriptors; (c) selecting a transport request descriptor from the plurality of transport request descriptors sequentially and repeatedly, and determine a command descriptor sequentially without repetition; (d) modifying the transport request descriptor according to the command descriptor; (e) reading the transport request descriptor to send a command in the command descriptor to the memory device; and (f) determining whether a last command descriptor of the plurality of command descriptors has been processed, if not, going back to step (c), and executing steps (c)-(f) in sequence.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to one embodiment of the present invention.

FIG. 2 is a diagram of allocating multiple UTRDs and multiple UCDs according to one embodiment of the present invention.

FIG. 3 is a flowchart of a command processing method according to one embodiment of the present invention.

### DETAILED DESCRIPTION

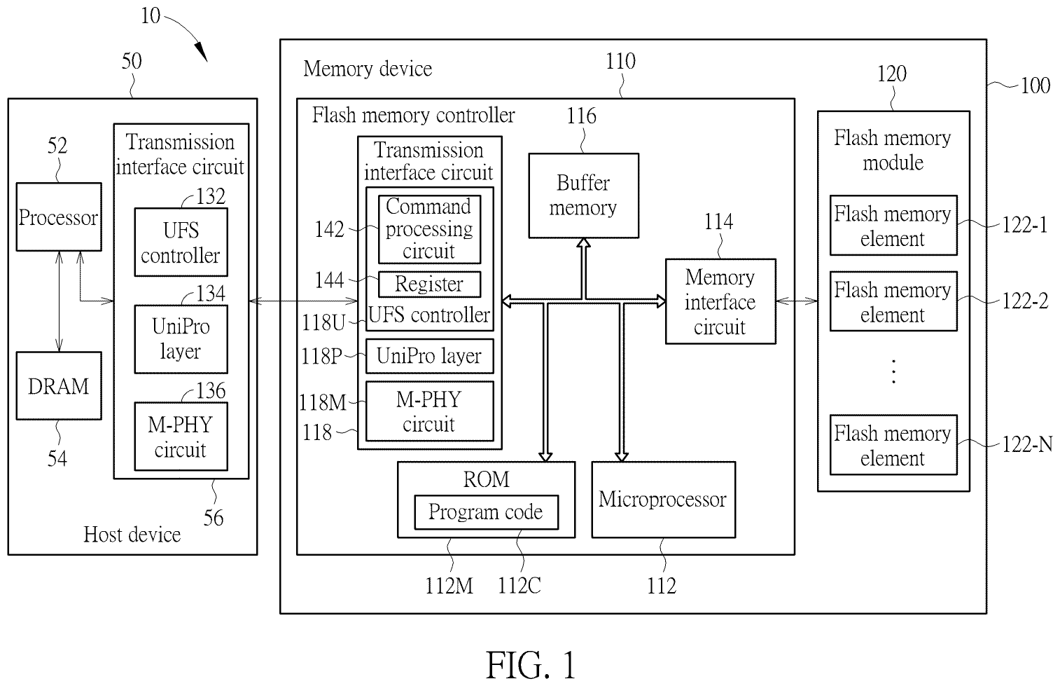

FIG. 1 is a diagram illustrating an electronic device 10 according to one embodiment of the present invention, wherein the electronic device 10 includes a host device 50 and a memory device 100. The host device 50 may include at least one processor 52 to control the operation of the host device 50, and the host device 50 may further include a dynamic random access memory (DRAM) coupled to the processor 52. The memory device 100 can be used to provide storage space to the host device 50 and obtain the one or more driving voltages from the host device 50 as a power source for the memory device 100. In one embodiment, the host device 50 can be a multifunctional mobile phone, a wearable device, a tablet computer, a personal computer or any other electronic device, and the memory device 100 can be an embedded storage device, such as an embedded storage device compliant with UFS standard. In this embodiment, the memory device 100 may include a flash memory controller 110 and a flash memory module 120, where the memory controller 110 is used to control the operation of the memory device 100 and access the flash memory module 120, and the flash memory module 120 is used to store information. The flash memory module 120 may include at least one flash memory element (such as one or more flash memory chips or one or more flash memory dies), such as a plurality of flash memory elements 122-1, 122-2, . . . , and 122-N shown in FIG. 1, where N is a positive integer greater than one.

As shown in FIG. 1, the flash memory controller 110 may include a microprocessor 112, a read-only memory (ROM) 112M, a memory interface circuit 114, and a buffer memory 116 and a transmission interface circuit 118, wherein the above components can be coupled to each other through a bus. The buffer memory 116 is implemented by a static random access memory (SRAM), and the buffer memory 116 can be used to provide internal storage space to the memory controller 110. In addition, the ROM 112M is used to store a program code 112C, and the microprocessor 112 is configured to execute the program code 112C to control the access of the flash memory 120. Please note that in some examples, the program code 112C may be stored in buffer memory 116 or any other type of memory. In addition, the memory interface circuit 114 may include an encoder and a decoder to encode data written to the flash memory module 120 or to decode the data read from the flash memory module 120. The transmission interface circuit 118 can comply with a specific communication standard such as the UFS standard, and can communicate with the host device 50 according to the specific communication standard. The transmission interface circuit 118 may include a UFS controller 118U, an M-PHY circuit 118M that complies with the relevant specifications of the MIPI Alliance, and a unified protocol (commonly referred to as UniPro) layer 118P, which may interact with each other, and the UFS controller 118U includes at least a command processing circuit 142 and a register 144.

In addition, the host device 50 further includes an interface transmission circuit 56 coupled to the memory device 100. The memory transmission circuit 56 includes a UFS controller 132, a UniPro layer 134 and an M-PHY circuit 136 that complies with specifications of MIPI Alliance.

In this embodiment, the host device 50 can transmit multiple commands to the flash memory controller 110, and the flash memory controller 110 will perform read operations or write operations on the flash memory module 120 based on these commands from the host device 50.

In this embodiment, in order to test the performance and limit of the memory device 100 in processing multiple commands, the host device 50 will continuously send many commands, for example, about 10,000 to 50,000 commands to the memory device 100. As mentioned in the prior art, the conventional host device architecture cannot quickly transmit a large number of commands to the memory device 100, thus resulting in a low efficiency in testing the memory device 100. Therefore, this embodiment proposes a method for testing the memory device 100, where the command processing method performed in the command processing method allows the host device 50 to quickly send a large number of commands to the flash memory controller 110 for processing.

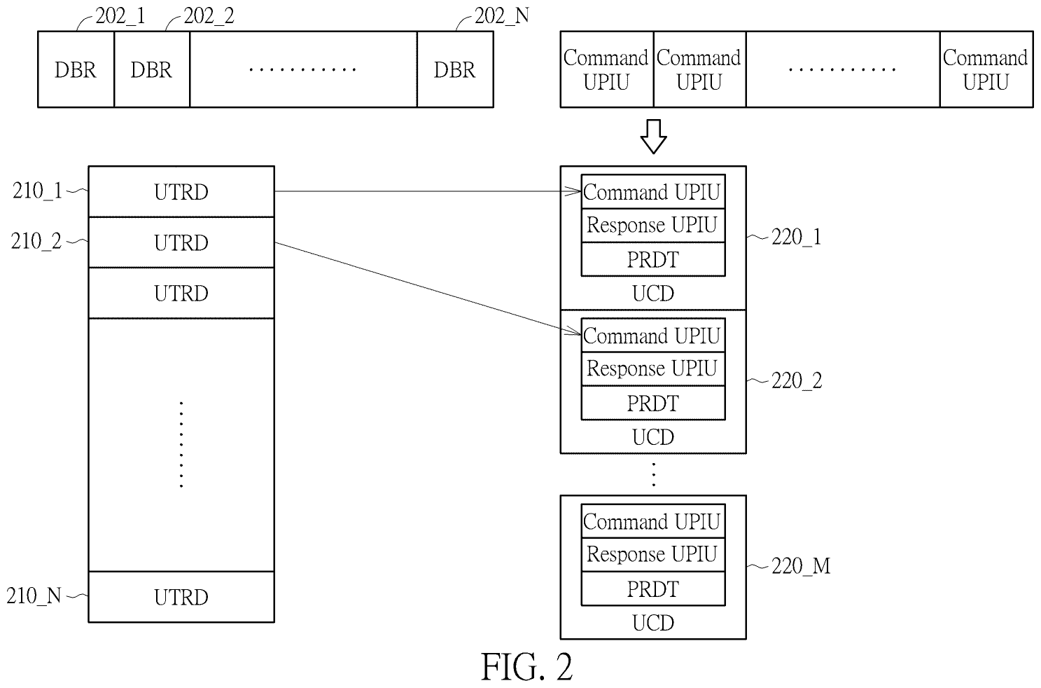

Specifically, referring to FIG. 2, the processor 52 in the host device 50 configures multiple UFS transport protocol (UTP) layer transport request descriptors (UTRD) 210_1-210_N in the DRAM 54, where the UTRDs are used for host device 50 to send commands to memory device 100. In this embodiment, the UTRDs 210_1-210_N may be defined in the architecture of Host Controller Interface (HCI) version 3.0 formulated by the Joint Electron Device Engineering Council (JEDEC), that is, the number of UTRDs configured by the processor 52 is 32 (that is, N is equal to 32), and the data structure of each UTRD includes at least a command type, a crypto configuration index (CCI), a data unit number lower 32 bits (DUNL), an overall command status, a data unit number upper 32 bits (DUNU), a UTP command descriptor base address, a UTP command descriptor base address upper 32 bits, a response UFS Protocol Information Unit (UPIU) offset, a response UPIU length, a physical region description table (PRDT) offset, a PRDT length, and so on. It should be noted that the UTRDs 210_1-210_N described in this embodiment may be consistent with the UTRD described in JEDEC UFS HCI version 3.0, or be compatible with the UTRD described in JEDEC UFS HCI version 3.0, and because a person skilled in the art can understand the functions and contents of UTRDs 210_1-210_N, the details will not be described here.

The processor 52 in the host device 50 also configures a plurality of UTP command descriptors (UCD) 220_1-220_M in the DRAM 54. The number of UCDs 220_1-220_M can be determined according to the number of test commands that the host device 50 needs to send to the memory device 100. For example, if the host device 50 needs to send 10,000 commands to the memory device 100 for testing, then the number of UCDs 220_1-220_M is 10,000 (that is, M is equal to 10,000). In this embodiment, each of the UCDs 220_1-220_M has the same size, and each of UCDs 220_1-220_M includes a command UPIU, a response UPIU and a PRDT, wherein the command UPIU refers to a command packaged in a UPIU packet, the response UPIU refers to a response message packaged in a UPIU packet from the memory device 100, and the PRDT describes address information that points to one or more data buffers. In one embodiment, the UCDs 220_1-220_M have consecutive addresses in the DRAM 54, but the invention is not limited thereto.

In addition, multiple doorbell registers (DBR) 202_1-202_N will be provided inside the UFS controller 132, where the DBRs 202_1-202_N correspond to the UTRDs 210_1-210_N, respectively, and each DBR is used to indicate whether the corresponding UTRD is in a state that can transmit a command. For example, if the value of the DBR 202_1 is “0”, it means that the UTRD 210_1 is currently unable to transmit commands; and if the value of the DBR 202_1 is “1”, it means that the UTRD 210_1 is in a state that can transmit a command. In this embodiment, only one of the DBRs 202_1-202_N has the value “1”, while the rest of the DBRs are all “0”, and the DBRs 202_1-202_N are sequentially and repeatedly has the value “1”. In addition, in this embodiment, a DBR is defined as a bit, but this definition is not a limitation of the present invention. In other embodiments, multiple bits can be regarded as a doorbell register, for example, 32 bits can be regarded as a doorbell register, and each bit corresponds to a UTRD, that is, at this time the symbol “DBR” shown in FIG. 2 is regarded as a bit in the doorbell register.

In the operation of the host device 50, first, the processor 52 can generate multiple command UPIUs in sequence, where these commands can include various different types of commands, such as inquiry commands of UFS based on Small Computer System Interface (SCSI), mode selection commands, pre-fetch commands, security protocol commands, commands, read write commands, verify command, . . . etc. The read commands and the write commands are regarded as commands that require user data transfer, the security protocol commands will transmit security-related user data or set data in the protection region, the inquiry commands and the mode selection commands transfers non-user data, and the remaining commands can be regarded as commands that do not require data transfer. At this time, the processor 52 sets the DBR 202_1 to “1”, and modifies the content of the UTRD 210_1 corresponding to the DBR 202_1 to describe the information of the UCD 220_1. For example, since each of the UCDs 220_1-220_M has the same size, and the sizes/lengths of the command UPIU, response UPIU, and PRDT are known, the processor 52 can modify the content of the UTRD 210_1 to describe the starting address of the UCD 220_1, response UPIU offset, response UPIU length, PRDT offset, PRDT length, . . . and so on. In addition, the UCDs 220_1-220_M serves as a software sequence, and the processor 52 writes the first command UPIU to the first field of UCD 220_1, and if this command UPIU is not a read command or a write command, the PRDT in the UCD 220_1 can remain blank or not point to any meaningful data buffer because this command does not require data transfer; and if this command UPIU is a read command or a write command, since this command requires data transfer, the PRDT in the UCD 220_1 will point to a data buffer in DRAM 54, where the data buffer includes the data that needs to be written to the memory device 100, or the data buffer is used to store data read from the memory device 100. It is noted that at this time, the response UPIU in the UCD 220_1 is blank or does not include any valid data.

In addition, at the same time, the processor 52 sequentially writes the subsequent command UPIUs into the subsequent UCD 220_2-220_M. Similarly, if this command UPIU is not a read command or a write command, the PRDT in the corresponding UCD can remain blank or not point to any meaningful data buffer because this command does not require data transfer; and if this command UPIU is a read command or a write command, since this command requires data transfer, the PRDT in the corresponding UCD will point to a data buffer in DRAM 54, where the data buffer includes the data that needs to be written to the memory device 100, or the data buffer is used to store data read from the memory device 100.

After the processor 52 completes the writing/modification of the UTRD 210_1 and the UCD 220_1, a direct memory access (DMA) circuit in the host device 50 will read the UTRD 210_1, and transmit the command UPIU in the UCD 220_1 to the memory device 100 based on the content of the UTRD 210_1. In addition, after the command UPIU in UCD 220_1 is transmitted to the memory device 100, the flash memory controller 110 in the memory device 100 will execute the command UPIU, and send a response message to the host device 50 based on whether the command UPIU is successfully executed, and at this time the response message will be written to the response UPIU within the UCD 220_1.

In this embodiment, in order to improve the speed of the host device 50 sending commands to the memory device 100, after the processor 52 knows that the command UPIU in the UCD 220_1 is sent to the memory device 100 through the DMA circuit, regardless of whether a response message is received from the memory device 100, the processor 52 will set the DBR 202_1 to “0”, set the DBR 202_2 to “1”, and modify the UTRD 210_2 corresponding to the DBR 202_2 to describe the information of the UCD 220_2. For example, since each of the UCDs 220_1-220_M has the same size, and the sizes/lengths of the command UPIU, response UPIU, and PRDT are known, the processor 52 can modify the content of the UTRD 210_2 to describe the starting address of the UCD 220_2, response UPIU offset, response UPIU length, PRDT offset, PRDT length, . . . and so on.

After the processor 52 completes the writing/modification of the UTRD 210_2 and the UCD 220_2, the DMA circuit in the host device 50 will read the UTRD 210_2, and transmit the command UPIU in the UCD 220_2 to the memory device 100 based on the content of the UTRD 210_2. In addition, after the command UPIU in UCD 220_2 is transmitted to the memory device 100, the flash memory controller 110 in the memory device 100 will execute the command UPIU, and send a response message to the host device 50 based on whether the command UPIU is successfully executed, and at this time the response message will be written to the response UPIU within the UCD 220_2.

Similarly, after the processor 52 knows that the command UPIU in the UCD 220_2 is sent to the memory device 100 through the DMA circuit, regardless of whether a response message is received from the memory device 100, the processor 52 will set the DBR 202_2 to “0”, set the DBR 202_3 to “1”, and modify the UTRD 210_3 corresponding to the DBR 202_3 to describe the information of the UCD 220_3.

Based on similar operations, the processor 52 sequentially modifies the contents of the UTRDs 210_4-210_32, and transmits the corresponding command UPIUs to the memory device 100 in sequence. Then, the processor 52 returns to the first UTRD 210_1 for processing, but does not return to the first UCD 220_1, that is, the processor 52 continues to sequentially start processing the UCD 220_33. Specifically, the processor 52 sets the DBR 202_1 to “1” and modifies the content of the UTRD 210_1 corresponding to the DBR 202_1 to describe the information of the UCD 220_33. At this time, the processor 52 writes the command UPIU to the first field of UCD 220_33. Afterwards, the DMA circuit reads the UTRD 210_33 and transmits the command UPIU in the UCD 220_33 to the memory device 100 according to the content of the UTRD 210_33.

Then, based on similar operations, the processor 52 sequentially modifies the contents of the UTRDs 210_2-210_32, and transmits the corresponding command UPIUs stored in the UCDs 220_34-220_64 to the memory device 100 in sequence.

Similarly, the processor 52 modifies the UTRDs 210_1-210_32 sequentially and repeatedly, and writes data to the remaining UCDs sequentially without repetition, until the command UPIU of the last UCD 220_M is transmitted to the memory device 100.

As mentioned above, since the processor 52 does not need to consider whether each command UPIU can be successfully executed by the flash memory controller 110 when transmitting the command UPIU to the memory device 100, that is, there is no need to read the response UPIU of each UCD, the processor 52 can quickly transmit many command UPIUs to the memory device 100 to improve the efficiency of command testing.

In addition, after all the command UPIUs generated by the processor 52 are transmitted to the memory device 100, the processor 52 begins to obtain the response UPIUs in the UCD 220_1-220_M to determine which one of UCD 220_1-220_M has a command execution error, so that the engineers can analyze the results of these command tests.

It should be noted that the UTRD and UCD in the UFS specification are used as explanations in the above embodiment, but the present invention is not limited thereto. In other embodiments, the UTRD may be replaced by a transport request descriptor corresponding to other flash memory specifications, and the UCD may be replaced by a command descriptor corresponding to other flash memory specifications.

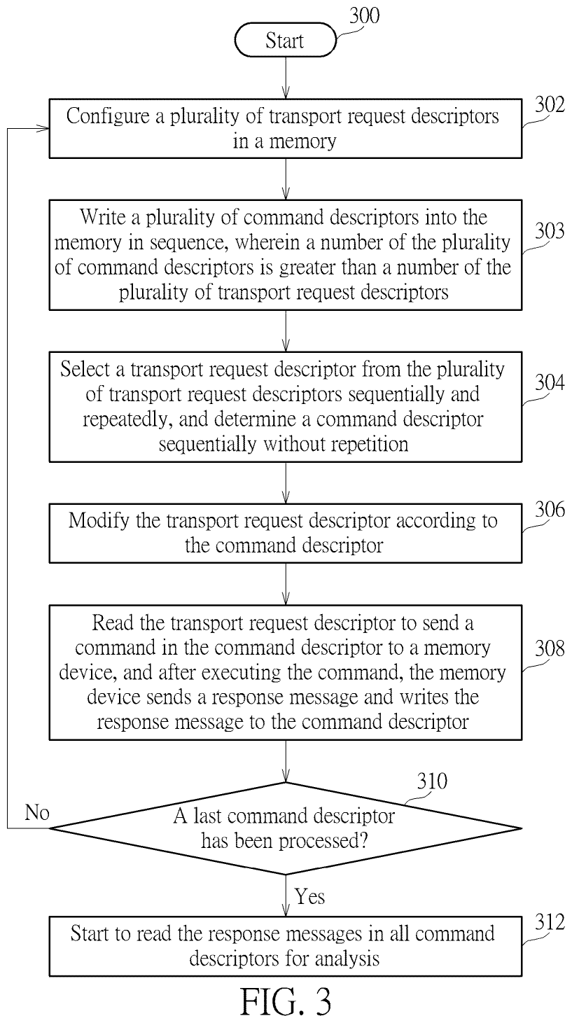

FIG. 3 is a flowchart of a command processing method according to one embodiment of the present invention. Referring to the above embodiments, the flow of the command processing method is described as follows.

Step 300: the flow starts.

Step 302: configure a plurality of transport request descriptors in a memory.

Step 303: write a plurality of command descriptors into the memory in sequence, wherein a number of the plurality of command descriptors is greater than a number of the plurality of transport request descriptors.

Step 304: select a transport request descriptor from the plurality of transport request descriptors sequentially and repeatedly, and determine a command descriptor sequentially without repetition.

Step 306: modify the transport request descriptor according to the command descriptor.

Step 308: read the transport request descriptor to send a command in the command descriptor to a memory device, and after executing the command, the memory device sends a response message and writes the response message to the command descriptor.

Step 310: determine whether a last command descriptor has been processed. If yes, the flow enters Step 312; and if not, the flow goes back to Step 302.

Step 312: start to read the response messages in all command descriptors for analysis.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A host device coupled to a memory device, wherein the memory device comprises a flash memory controller and a flash memory module, and the host device comprises a processor, and the processor is configured to perform the steps of:
(a) configuring a plurality of transport request descriptors in a memory;
(b) writing a plurality of command descriptors into the memory in sequence, wherein a number of the plurality of command descriptors is greater than a number of the plurality of transport request descriptors;
(c) selecting a transport request descriptor from the plurality of transport request descriptors sequentially and repeatedly, and determining a command descriptor sequentially without repetition;
(d) modifying the transport request descriptor according to the command descriptor;
(e) reading the transport request descriptor to send a command in the command descriptor to the memory device; and
(f) determining whether a last command descriptor of the plurality of command descriptors has been processed, if not, going back to step (c), and executing steps (c)-(f) in sequence.

2. The host device of claim 1, wherein each of the plurality of transport request descriptors is a universal flash storage (UFS) transport protocol layer transport request descriptor (UTRD), and each of the plurality of command descriptors is a UFS transport protocol (UTP) command descriptor (UCD).

3. The host device of claim 2, wherein each of the plurality of command descriptors comprises a command UFS protocol information unit (command UPIU), a response UPIU and a physical region description table (PRDT).

4. The host device of claim 3, wherein in step (d), after the memory device executes the command, the memory device sends a response message and write the response message to the response UPIU of the UCD, and the processor does not refer to the response UPIU within the UCD during the execution of steps (a)-(f).

5. The host device of claim 1, wherein in step (d), after the memory device executes the command, the memory device sends a response message and write the response message to the command descriptor; and when it is determined in step (f) that the last command descriptor has been processed, the processor further performs the following step:
starting to read the response messages in all of the plurality of command descriptors for analysis.

6. An electronic device, comprising:
a memory device comprising a flash memory controller and a flash memory module; and
a host device, coupled to the memory device, wherein the host device comprises a processor, and the processor is configured to perform the steps of:
(a) configuring a plurality of transport request descriptors in a memory;
(b) writing a plurality of command descriptors into the memory in sequence, wherein a number of the plurality of command descriptors is greater than a number of the plurality of transport request descriptors;
(c) selecting a transport request descriptor from the plurality of transport request descriptors sequentially and repeatedly, and determining a command descriptor sequentially without repetition;
(d) modifying the transport request descriptor according to the command descriptor;
(e) reading the transport request descriptor to send a command in the command descriptor to the memory device; and
(f) determining whether a last command descriptor of the plurality of command descriptors has been processed, if not, going back to step (c), and executing steps (c)-(f) in sequence.

7. The electronic device of claim 6, wherein each of the plurality of transport request descriptors is a universal flash storage (UFS) transport protocol layer transport request descriptor (UTRD), and each of the plurality of command descriptors is a UFS transport protocol (UTP) command descriptor (UCD).

8. The electronic device of claim 7, wherein each of the plurality of command descriptors comprises a command UFS protocol information unit (command UPIU), a response UPIU and a physical region description table (PRDT).

9. The electronic device of claim 8, wherein in step (d), after the memory device executes the command, the memory device sends a response message and write the response message to the response UPIU of the UCD, and the processor does not refer to the response UPIU within the UCD during the execution of steps (a)-(f).

10. The electronic device of claim 6, wherein in step (d), after the memory device executes the command, the memory device sends a response message and write the response message to the command descriptor; and when it is determined in step (f) that the last command descriptor has been processed, the processor further performs the following step:
starting to read the response messages in all of the plurality of command descriptors for analysis.
